(19) United States
(12) Patent Application Publication
(10) Pub. No.: US 2012/0179076 A1
(43) Pub. Date: Jul. 12, 2012

(54) Method and system for treating amblyopia

(76) Inventors: Daphne Bavelier, Rochester, NY (US); Dennis Levi, Berkeley, CA (US); Zhong-Lin Lu, Irvine, CA (US); Alvaro Pascual-Leone, Wayland, MA (US)

(21) Appl. No.: 13/200,080

(22) Filed: Sep. 16, 2011

Related U.S. Application Data
(60) Provisional application No. 61/403,585, filed on Sep. 16, 2010.

(51) Int. Cl. A61H 5/00; G09G 5/00

(52) U.S. Cl. 601/37; 345/619

(57) ABSTRACT

A system and method for treating amblyopic individuals through an engaging treatment modality which considers binocular function in adapting treatment. The present invention may be practiced by providing a dichoptic display having multiple sub-displays; providing a video game system and controller in communication with the dichoptic display; running a game program having a graphical presentation; using one sub-display to display a first view of the presentation and a second sub-display to display a second view of the presentation; and altering at least one of the first or second view of the presentation.

### CROSS-REFERENCE TO RELATED APPLICATION

This application claims the benefit of priority to U.S. provisional patent application Ser. No. 61/403,585, filed on Sep. 16, 2010, now pending. The disclosure of the above priority document is incorporated herein by reference.

This invention was made with government support under grant EY EY020976 awarded by the National Eye Institute and/or grant R01 EY016880 awarded by the National Eye Institute. The government has certain rights in the invention.

### FIELD OF THE INVENTION

The invention relates to the field of treatment for individuals with amblyopia.

### BACKGROUND OF THE INVENTION

Amblyopia is the leading cause of visual impairment in children and affects approximately 3-5% of the population worldwide. The disorder causes a syndrome of monocular and binocular deficits that persist after optical correction and in the absence of observable ocular pathology. These deficits include reduced letter acuity, a loss of contrast sensitivity, presence of visual distortions, reduced stereo-acuity, and abnormal binocular combination and interaction. The primary causes of amblyopia are anisometropia, a refractive imbalance between the eyes, and strabismus, a misalignment of the ocular axes.

Conventional treatment for amblyopia only applies to children under 8 yrs of age, and is unsuccessful in 25-50% of cases and rarely restores normal binocular vision.

In the past twenty years, several laboratories have demonstrated that perceptual training can exploit neural plasticity in the adult amblyopic visual system for visual rehabilitation. However, these therapies, like the conventional occlusion/penalization treatment for children, have typically been monocular, neglecting binocular functions, and limited to the laboratory as they are not patient friendly.

### BRIEF SUMMARY OF THE INVENTION

It is therefore an object of the present invention to provide a system and method for treating amblyopic individuals through an engaging treatment modality which considers binocular function in adapting treatment. In particular, a system or method according to the present invention may incorporate: (i) the use of high quality, embodied experience during which vision has to work for the purpose of well-targeted motor action, (ii) the use of brain stimulation to disrupt the state of the cortex and accelerate learning.

### DESCRIPTION OF THE DRAWINGS

The patent or application file contains at least one drawing executed in color. Copies of this patent or patent application publication with color drawing(s) will be provided by the Office upon request and payment of the necessary fee.

For a fuller understanding of the nature and objects of the invention, reference should be made to the following detailed description taken in conjunction with the accompanying drawings, in which:

FIG. 1 is flowchart of a method according to an embodiment of the present invention;

FIG. 2 is a block diagram of a system according to an exemplary embodiment of the present invention;

FIG. 3 is a view of a dichoptic display viewer with two sets of mirrors facing a conventional computer display screen, which shows two images, one intended for the right eye, and the other for the left eye. A chin rest at the front enables the correct positioning of the individual's head;

FIG. 4 shows a first view and a second view of a graphical presentation showing decreased brightness of the view displayed to the good eye (in this case the image on the right;

FIG. 5 shows a first view and a second view of a graphical presentation showing decreased contrast of the view displayed to the good eye (in this case the image on the right;

FIG. 6 shows the views of FIG. 5 with a Gabor patch placed over an element of the left image; and

FIG. 7 shows an exemplary tDCS system, in this case, the cathode is disposed on the back of the head and the anode is disposed on the forehead.

### DETAILED DESCRIPTION OF THE INVENTION

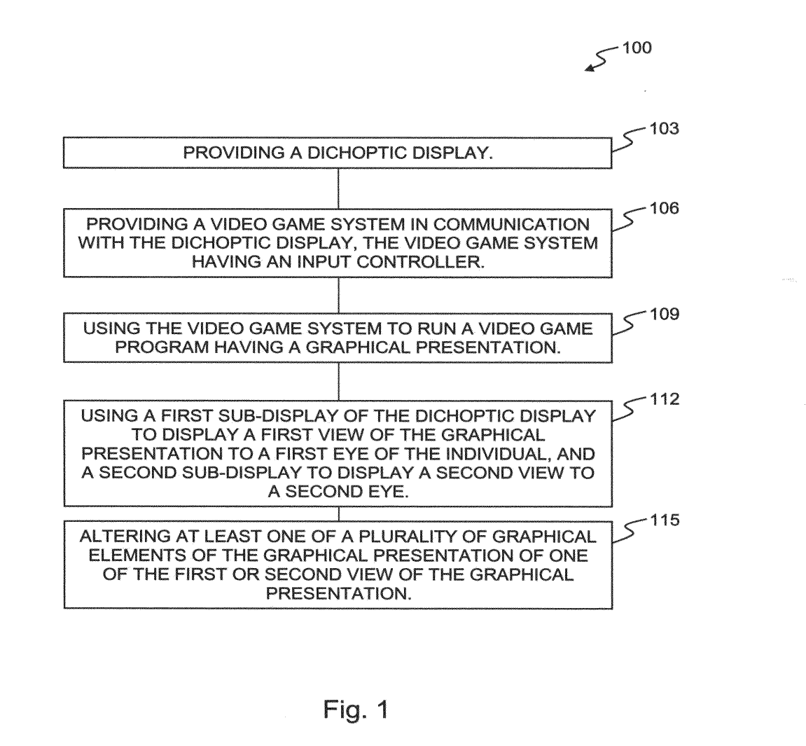

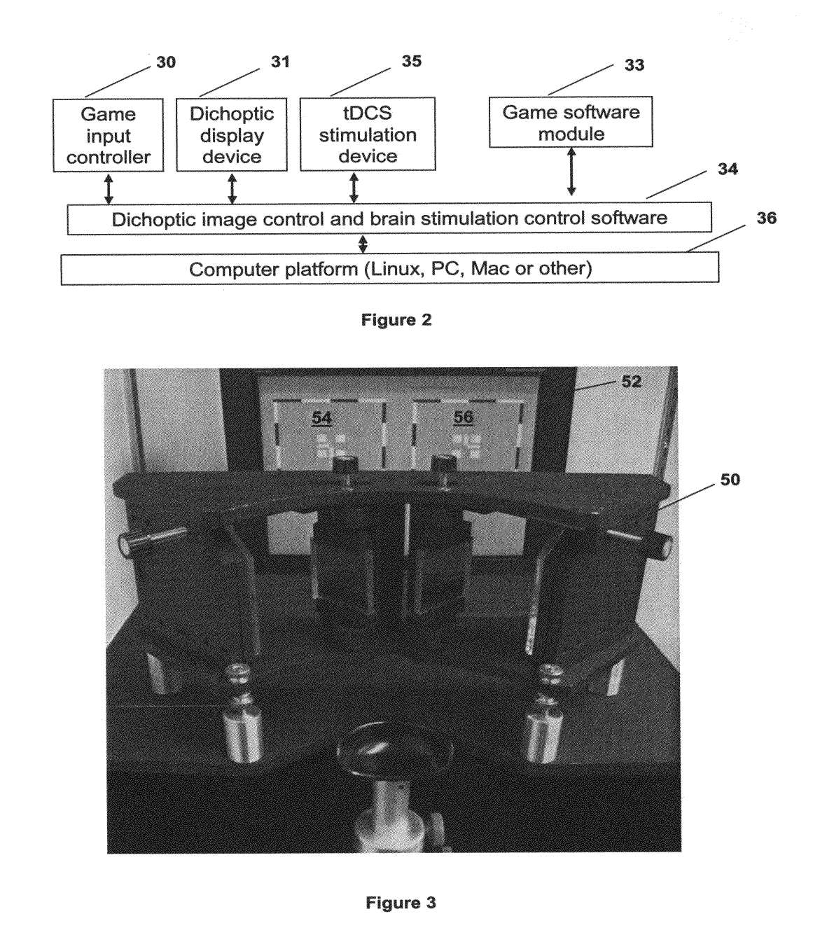

In a method 100 according to an embodiment of the invention (FIG. 1) an individual may be treated for amblyopia by providing 103 a dichoptic display. The dichoptic display has a first sub-display and a second sub-display corresponding with the two eyes of the individual. The first and second sub-displays are configured such that each eye of the individual sees an image provided by one sub-display. As such, each eye sees an image that may be different from the image seen by the other eye. Such a dichoptic display may be a monitor configured for dichoptic images (via shutter glasses or other technology), a wearable display such as glasses with displays for each eye, or other technology. FIG. 2 depicts an exemplary dichoptic display in the form of a mirror system 50 able to display a different portion 54, 56 of a monitor 52 to each eye of the individual.

A video game system is provided 106. The video game system is used 109 to run a video game program which generates a graphical presentation of a game for display to the individual. The video game system is in communication with the dichoptic display such that the graphical presentation generated by the video game system is viewable by the individual by way of the dichoptic display. The video game system is capable of generating different views of the graphical presentation for display. For example, a first view of the graphical presentation may be displayed to the first eye of the individual using 112 the first sub-display of the dichoptic display. Similarly, a second view of the graphical presentation may be displayed to the second eye of the individual using 112 the second sub-display. As such, the same or different visual information may be displayed to each eye of the individual. Each view may differ in the amount of information, the clarity of information, or similarly to encourage the use of one eye over the other. Each eye may receive a view of a virtual world from different camera angles such that the individual is “immersed” in a three-dimensional virtual world generated by the video game system.

The video game system has an input controller enabling the individual to interact with the video game. The input controller is similar to those known in the art. For example, the input controller may be corded or cordless. The input controller may have buttons, may have accelerometers to detect movement of the controller, or a combination of these. The input controller may function by way of a movement of the individual. For example, the input controller may detect movement when held by or attached to the individual. In another embodiment, the input controller may be stationary and sense the movement of the individual by way of cameras, lasers, ultrasound, or other technologies known in the art.

The graphical presentation has a plurality of graphical elements. For example, in a “first person shooter” genre game (wherein the individual is immersed in a three-dimensional game in which he or she must shoot targets), graphical elements may be walls, floors, enemy targets, tables, chairs, etc. First person shooter games and other action video games encourage precise motor control for visually guided aiming. The video game system is used to generate the plurality of graphical elements and display the views of the elements to the individual using the dichoptic display.

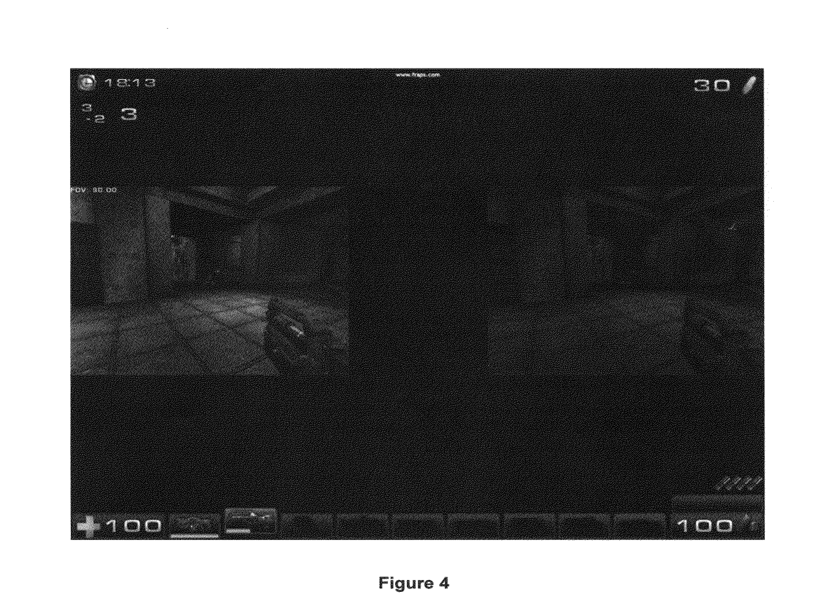

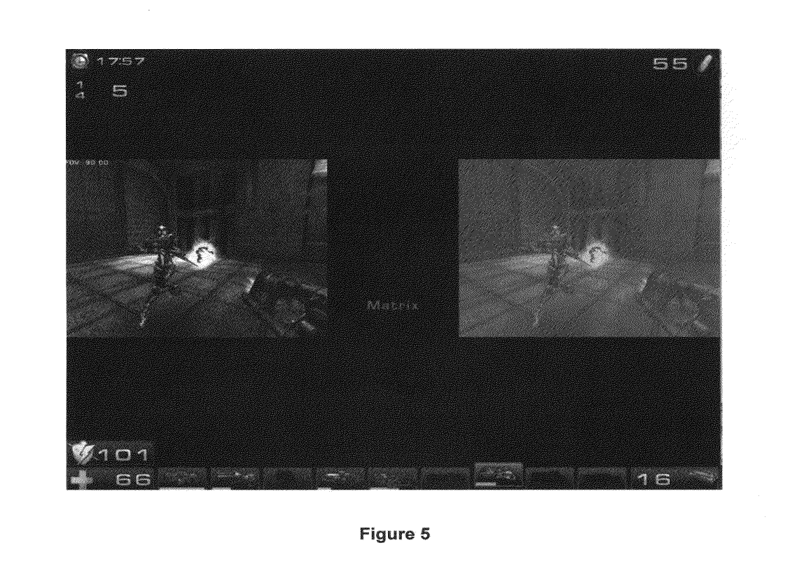

Once generated by the video game system, the graphical elements may be altered 115 for use in treating an individual with amblyopia. In the example from above, a graphical element, such as an enemy target, may be displayed by only one sub-display to only one eye of the individual. In another embodiment, the quality of the graphical element or the entire view may be displayed differently in each eye. For example, the luminance (e.g., FIG. 4), color, contrast (e.g., FIG. 5), blur, and/or other characteristic of the graphical element may be different in one eye than the other. Any of these techniques may be used individually or combined. In this way, the “good” eye of the individual may receive a lesser display than the amblyopic eye, thus training the individual to increasingly rely on the amblyopic eye.

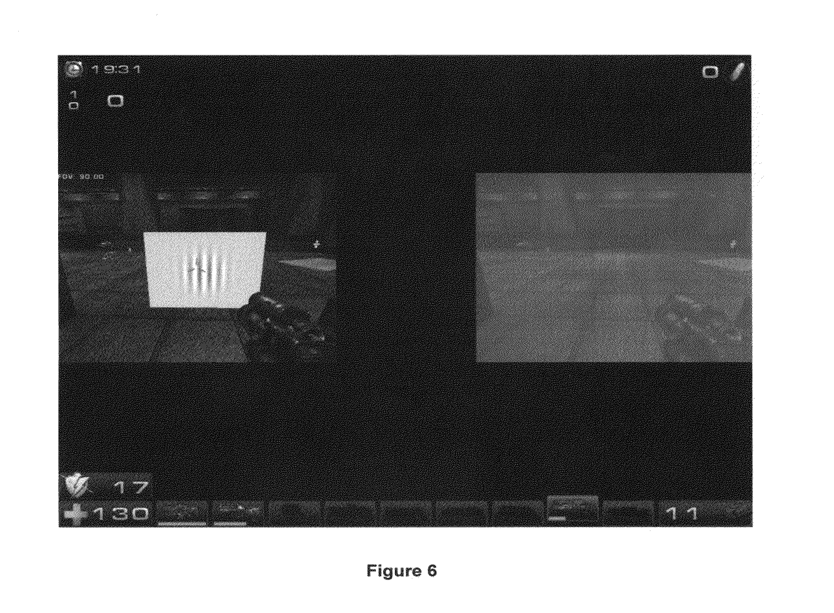

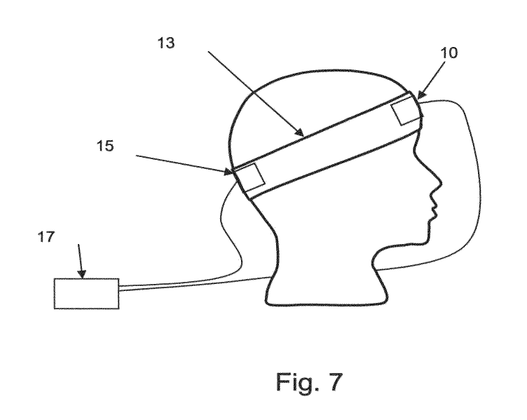

The graphical element may be altered using a specific luminance patter, which may be a sinusoidal luminance pattern. The graphical element may be altered using a Gabor patch (e.g., FIG. 6). The graphical element may be altered using different luminance patterns in each eye, or no pattern in one eye.

At times before, during, or after game play, a nonius stimulus may displayed using the dichoptic display. Such stimulus may be used to detect the binocular alignment of the individual. For example, in a simple form, using the sub-displays of the dichoptic display, a vertical line may be displayed to one eye of the individual and a horizontal line may be displayed to the other eye. The individual will determine whether the lines form a “cross” in the individual's combined visual field, or if the lines are misaligned. If misaligned, the individual may provide feedback to the video game system by way of the input controller to indicate whether a line should be shifted left, right, up, or down in order to perceive a proper “cross” shape. The video game system will respond to this feedback by adjusting the alignment of the images until the individual perceives the correct image.

The nonius stimulus may be a more robust visual test in order to maintain the individual's interest. For example, the game being played by the individual may be a car racing game. In this case, the car may be displayed to one of the individual's eyes and the track may be displayed to the other eye. The binocular alignment may then be determined by the individual's efforts to drive the car on the track (e.g., the individual may consistently drive the car on the median to the left of the track). The alignment of the images can then be adjusted manually or automatically by the system until the car is properly aligned with the track. This concept can be applied with other games, for example but not limited to, target shooting, sports simulators, and the like.

At times before, during, or after game play, a suppression check may be performed to determine the visual fusion of the individual. An individual may suppress a portion, several portions, or the entirety of their vision in an eye. To encourage a balance between the eyes (visual fusion), the images displayed to the non-suppressed eye may be altered to cause more reliance on the suppressed eye. Suppression may be checked by displaying images to each eye which differ in ways so as to determine the field of view of each eye. For example, dots or other objects may be displayed to the weaker eye of the individual. In one embodiment for a shooting game, a background image may be displayed to one or both eyes and targets may be displayed to the individual's weaker eye. In such cases, suppression may be determined according to the locations of targets which are not noticed. In another example, different portions of a cross-hair image may be displayed to each eye, thereby encouraging balance between the eyes. Such cross-hair portions may be the same or different colors. Other games can be used in similar fashion to determine suppression/visual fusion.

Once suppression of the individual is mapped, the views displayed to each eye may be altered such that the suppressed eye is used more. For example, the view displayed to the good eye may be altered to be dimmer at the locations which correspond to the suppressed locations of the weak eye. The image may be altered in contrast, color, or any other characteristic to cause the weak eye to be used more.

Both visual fusion and binocular alignment may be tested multiple times during use of the video game system because these traits may change over time. Incorporating the suppression check and nonius stimulus into game play (as described above), however, may be implemented so as to be non-invasive and unnoticed by the individual.

The game may be designed around orientation discrimination tasks. These tasks may be embedded within the structure of the game. For example, the game may monitor changes in the individual's spatial resolution during the course of training. In this example, correct responses are rewarded with game points and incorrect responses are penalized by spawning additional targets.

In order to acclimate individuals to the video game system, scenarios of increasing complexity may be presented. For example, the first presented scenario may comprise a cylindrical map having minimal complexity. The cylindrical map could be used to teach individuals how to navigate through the game in a straight line. Another scenario may comprise a square map with both curved corners and sharp edges. The square map could be used to teach individuals how to turn around corners. A more complex map might include the features of the previous maps but also include obstacles the individual must navigate around.

Embodiments of the present invention may also comprise use of a transcranial direct current stimulation system. Transcranial Direct Current Stimulation (“tDCS”) is performed by causing a low-current electrical stimulus to be applied to the individual. Generally, one or more batteries 17, for example 9-volt batteries, are used in conjunction with electrical probes in contact with the individual to cause a DC low-current flow of approximately 1-2 mA through the individual. This current is generally sustained and continuous during the application period. It is believed that brain activity is encouraged in the portion of the brain proximate the anode 10, and suppressed in the portion of the brain proximate the cathode 15. Therefore, depending on the application the anode 10 may be placed on the individual's scalp proximate to an area where increased activity is desired and/or the cathode 15 may be placed on the individual's scalp proximate to an area where decreased activity is desired. A probe may also be disposed extracephalic (off of the head—e.g., on the shoulder) if no corresponding brain stimulus is desired.

The occipital region of the brain is primarily responsible for visual processing. In individuals having amblyopia, it is believed that high activity in the occipital region is due to processing of information from the “good” eye. In order to encourage processing of images from the amblyopic eye, therefore, it may be beneficial to suppress activity of the brain in the occipital region. Hence, when used in conjunction with other elements of the present invention, a preferred configuration of a tDCS system is to place the cathode 15 on the scalp proximate to the occipital region, and place the anode 10 on the forehead or shoulder. Such a configuration may be accomplished using electrical probes disposed in sponges and secured by a headband 13 (as is known in the art). Such a configuration may also be accomplished using more socially acceptable and easier to use devices. For example, the electrical probes may be attached to a hat. In this way, when the hat is worn by the individual, the electrical probes will be positioned properly.

When used with embodiments of the present invention, tDCS may be applied to the individual before, during, after, or any combination of these. Use before game play may cause the brain to be more receptive to the effects of video game treatment, use during game play may enhance the effect of video game treatment, and use afterward may cause the brain to better consolidate the effects of the treatment. tDCS functions by drawing electrolytes to the region of the body proximate to the anode 10. This movement of electrolytes may take a period of time; therefore, tDCS may be started several minutes before the desired treatment period in order to allow movement of the electrolytes.

The present invention may be embodied as a system for treating an individual having amblyopia. The system is in keeping with the method more thoroughly described above. The system comprises a dichoptic display capable of displaying different information to each eye of the individual. A video game system is in communication with the dichoptic display. The video game system is configured to display graphical information to the individual using the dichoptic display. The system further comprises an input controller in communication with the video game system. The input controller is configured to allow the individual to interact with the video game system. The system may include a transcranial direct current stimulation system for providing electrical stimulation to the individual.

The present invention may be embodied as a video game program on a computer tangible medium. The video game program is in keeping with the method described above. The video game program may be encoded on a computer readable storage medium. The video game program is capable of instructing a computer to generate a graphical presentation containing a plurality of graphic elements. The graphical presentation change over time and be perceived as motion. The video game program generates a first view and a second of the graphical presentation. Each view may be generated for viewing by the separate eyes of an individual using a dichoptic display. At least one graphical element of the presentation may be altered. The graphical presentation is displayed on a dichoptic display. The video game program receives input from the individual by way of an input controller.

In an exemplary, non-limiting embodiment of a system according to the present invention, the device includes six components (FIG. 2):

1—Software for a dichoptic image and brain stimulation control, with interface to action-based game module 34;

2—Game software module, with age, gender and preference specific content 33;

3—Game input controller 30;

4—Dichoptic display device 31;

5—Hardware for an integrated Transcranial Direct Current Stimulation (tDCS) 35;

6—Computer platform (Linux, PC, Mac or other) 36.

Each component is further described below.

Dichoptic Image and Brain Stimulation Control Software 34

One exemplary vehicle for training the eye-brain system is a dichoptic action-based game specifically developed for amblyopes. The system may also be adaptable to low-vision patients. The control software would have a standard interface to a game module 33, which would have the plot and action of a typical entertainment video game. The control software 34 would have at least the following elements:

(i) the capability for a dichoptic presentation in a split screen of the game for a side by side view in order to have independent control of the images projected to the right eye and the left eye,
(ii) capability to degrade the images projected to the fellow eye with the ability to adjust the level of degradation at any time based on an equalizing procedure,
(iii) an equalization procedure in which participants are presented with static and dynamic scenes presented such that the scene will be clearly complete only if fusion is successful
(iv) capability to generate special training images having a sinusoidal luminance pattern (Gabor patches) to be embedded into the game to train the amblyopic eye.
(v) capability to generate nonius stimuli for binocular alignment to assure that both eyes are collaborating even during game play.
(vi) capability to generate “suppression check” screens to ensure fusion.
(vii) capability to control the tDCS system.

Game Software Module 33

The underlying game module may have a very rich yet learnable environment with a good script in which players reach goals, unlock mysteries, discover new lands and the like. This aspect of game play, which provides the arousal and reward players seek in the video game experience, may be important when accelerating brain learning. The game module may comprise the following elements:

(i) The game may have a wider range of skill levels than a conventional entertainment game including very easy introductory levels and computer controlled opponents to the game so that older adults or individuals with little to no computer or video game experience may be able to master the skills required to play and progress to become a more expert player,

(ii) The game plot and graphics may be selected to be appropriate and attractive for the age and gender of the individual. Typical entertainment action video games tend to be scripted for a particular young male audience. Games may be designed with appropriate scripts, for example, including gender specific protagonists, in consideration of the gender and the age of the target population.

(iii) Embedded into the game may be elements having a sinusoidal luminance pattern (Gabor patches) to train the amblyopic eye. These elements may be integrated into the plot of the action and reward structure of the game.

(iv) Embedded into the game may be nonius stimuli for binocular alignment to assure that both eyes are collaborating even during game play.

(v) Embedded into the game may be “suppression check” screens to ensure fusion.

(vi) The game display may be graphically rich, very dynamic, covering a wide range of luminance context, and include many targets for the individual to track throughout the game.

(vii) The game may have a controlled pace in which the rate of exposure to information is increased.

Game Input Controller 30

The game controller 30 may be intuitive and ergonomic to the player. Some game console controls for inexpensive entertainment games are cumbersome and may slow down the learning. The game controller 30 may also provide robust tactile and force feedback, so that the visual experience of the player is enhanced by being able to feel, in real time, the outcome of their action.

Dichoptic Display Device 31

Since this system may be used in a home setting, rather than a clinic, a range of low-cost, easy-to-use dichoptic devices may be used. The display system 31 may:

(i) be integrated with a real-time control interface such that the game controller 30 interfaces with the display allowing the individuals to play as they do with an entertainment console or a computer;
(ii) allow for a wide variety of inter-ocular distance adjustments, as well as inter-ocular deviations so as to adjust to any eyes deviations possible in patients. Such deviations may include left-right adjustments, up-down adjustments, and/or rotations;
(iii) allow for optical corrections as needed;
(a) One such device 31 is a simple adjustable mirror assembly with a chin rest, which fits in front of a computer display, such as the device show in FIG. 3.
(b) Another device may be liquid crystal shutter glasses that display alternating images from the two eyes with high temporal frequency. In one such device, the frequency may exceed 60 Hz.
(c) Another device may be an LCD or OLED head-mounted display that simultaneously displays two images with certain disparities to the two eyes.
(d) Another device may be a DLPT™-based dichoptic head mounted display as described by Woods, Apfelbaum and Peli in Journal of Biomedical Optics 15 (1) January 2010.
(e) Another device may include a modification of the stereoscopic technology developed by Dynamic Digital Depth which works on 3D ready TV displays from Samsung. See, for example, http://www.ddd.com/technology/technology.html.

Hardware for Transcranial Direct Current Stimulation 35

Part of the system may include a device for transcranial direct current stimulation. Transcranial Direct Current Stimulation (tDCS) is a method for noninvasive stimulation of the brain by applying a small anodal or cathodal current through a patch on the head. Most of the current remains in skin and skull, but enough enters the cortex to promote a shift in extracellular charged ions and ultimately a modulation of cellular resting potential. A small patch may be applied to the head, with current from a power supplier 17 controlled by the dichoptic image control and brain stimulation control software 34.

Computer Platform 36

The computer platform 36 could be a general purpose PC, Linux or Mac computer with interfaces to the display 31, games input controller 30 and tDCS device 35, or it may be a computer board in a dedicated device.

The present invention capitalizes on engaging the motor system to promote learning and brain plasticity. Physical exercise, whether in animal or human adults, is associated with improved hippocampal functions and reorganization of somatosensory maps. Similarly, it is important to embed the learning experience in a richer visuomotor context whereby vision has to work in the service of complex motor outputs. A method for improving stereopsis of an amblyopic individual using video games is disclosed.

The disclosed methods utilize games adapted from entertainment videogames. There may be differences between entertainment video games and games developed for clinical purposes.

One difference may concern the richness of the environment. Games developed for clinical purposes often mirror the type of psychophysics tasks that are typically used in vision laboratories (reading letters, looking for a geometric shape among other geometric shapes, detecting Gabor patches of different frequencies etc). In doing so, they provide the learner with an aggregate of rather impoverished visual tasks. In contrast, entertainment videogames are designed to give the learner a fully integrated experience in a very rich yet learnable environment. Successful game developers have designed their games to be challenging, yet allow the player to progress.

A second difference may be that a successful video game has a good script. Players generally are not motivated because they like the task they have been assigned. Instead, they may play to reach goals, unlock mysteries, discover new lands and the like. This aspect of game play is seldom present in games developed for clinical purposes, yet it is likely to be a factor in the arousal and reward players seek in the video game experience. As further discussed below, these are believed to be important in triggering the release of neuromodulators that foster brain plasticity.

In one example of the present invention, an action video game, Unreal Tournament® 2004 was adapted to be used as a training tool for amblyopes. This game is adapted to enhance perceptual learning as well as encourage the restoring of balanced inputs between the two eyes if one is to achieve durable gains. There are several reasons for choosing an action video game in some embodiments.

First, action game play enhances not only early aspects of vision but also higher ones, such as visuo-spatial selective attention, aspects of visual short-term memory, and the ability to select a target in an ever-changing stream of stimuli. These enhanced capacities benefit amblyopes who not only suffer from low-level vision problems, but also exhibit higher level vision deficits.

Second, by capitalizing on the “fun” factor, action video game play provides the ideal training tool by fostering deliberate practice. Literature on expertise not only shows that 10,000 hours of training are necessary to become an expert, but have established that the best determinant of learning success is what is termed deliberate practice or the willingness of the learner to subject him or herself to training. According to this literature, choosing to train, or as described here play, an action game over other activities, say going to a movie, is the best predictor of learning success. A great appeal of entertainment videogames is that people are not only willing to play these games, but they deliberately will spend hours subjecting themselves to the training regimen.

Third, videogame play is a popular activity in part because it is an arousing and extremely rewarding activity. After all, people are ready to pay for these games because they like playing, not because they believe it may be good for them. These games may therefore trigger the appropriate milieu that fosters brain plasticity. Playing a simple action video game has been associated with significant release of dopamine. This does not mean that one has to seek action gaming to benefit from playing. Indeed, training studies show that females who do not typically choose to subject themselves to action video game play benefit from such training. Anecdotal observations from female players suggest that they do “get into it” while they play. One recent study by Feng, Spence & Pratt (2007) even suggests greater visual attention benefits in females than in males following action game training.

Fourth and probably related to these last points, the issue of compliance with the training regimen, which is so thorny for more standard training method, is much alleviated with an activity as engrossing as video games.

It is acknowledged that, given the possibility of violent content, the choice of an action video game may not be suited to pediatric populations. Thus, other embodiments also address the development of games appropriate for pediatric populations and may use the same engine as the action game used with adults. Gender specific protagonists for male and female populations may also be utilized.

Video game training may be followed with a focused stereo training regimen. Most amblyopic patients have either reduced or no stereopsis. Since amblyopia arises from abnormal binocular interactions, an important goal of treatment should be the restoration or improvement of stereopsis.

Stereopsis may also be improved by: (1) embedding training in a natural visuomotor task in which stimuli are naturalistic and error feedback is implicit in the task, (2) providing a scaffolding for developing stereopsis by having monocular cues present in the stimuli, (e.g., by providing information correlated with stereoscopic cues), but (3) titrating them from highly reliable to completely unreliable to manipulate the pressure on the visual system to improve stereoscopic depth perception, and (4) providing the capability to assess stereoscopic depth perception continuously during training using performance measures derived from the same trials used for training.

In sum, the focus of the training may not only on the amblyopic eye, but also on “higher-level” visual skills and stereopsis, as an objective is to improve quality of life as reported by the patients. Enhancements after video game play are due to observers being better able to select and use the most reliable information for the task, as is the case in perceptual learning.

Yet, unlike perceptual learning whereby the observer typically learns the best template for the trained task, action garners may learn to find the best template on the fly as they are faced with new visual stimuli and new environments. According to this view, it has been shown that performance enhancements in action garners can be understood as the result of observers performing better probabilistic inferences as new tasks or environments are encountered. Having access to a training regimen that naturally leads to improvements across many different visual tasks may be highly beneficial in the treatment of amblyopia as amblyopes suffer not only from low-level vision losses, but also from higher-level vision losses.

Transcranial Direct Current Stimulation may be used as an adjunct to the training of the visual-brain system. tDCS is a method for noninvasive stimulation of the brain based on Faradization principles. For example, a small anodal or cathodal current may be applied continuously for 10 to 40 min transcranially. Most of the current remains in skin and skull, but enough enters the cortex to promote a shift in extracellular charged ions and ultimately a modulation of cellular resting potential. Thus tDCS is a purely neuromodulatory technique that can increase or decrease spontaneous and induced firing of neurons and so promote plastic changes.

DC polarization was used in a series of experiments on the cortex of rats and cats in the 1960's. These demonstrated that weak anodal polarization increased the firing rate of tonically discharging neurones, whereas cathodal polarization decreased firing rates. If polarization was applied for several minutes, the changes in discharge rate persisted after the stimulation was stopped for minutes to hours depending on the duration and strength of polarization. Cathodal tDCS can depress cortical excitability, while anodal tDCS can enhance it. Animal models and in-vitro studies demonstrate that tDCS, depending on polarity, modulates and induces synaptic plasticity: LTP by anodal and LTD by cathodal tDCS respectively.

Nitsche and Paulus introduced a viable protocol for use of tDCS in human studies capable of inducing consistent results. They applied a current of 1 mA from a constant current source 17 through relatively large pad electrodes of 35 cm2 placed on the scalp. The current density of this stimulation is so low that the stimulus is usually only perceived during the rapid change in current at onset and offset of the pulse. It is thus very easy to sham stimulate subjects by slowly ramping down the intensity after switch on, and ramping up before switch off. Several centers now routinely apply stimuli of up to 2 mA in order to obtain stronger and more reproducible effects ad have found these setting to be safe. Instead of using two scalp mounted electrodes it is possible to employ an extra-cranial position for the second electrode; for example, the second electrode may be placed on the shoulder. This can provide greater specificity of the stimulation effects on the brain.

Focality of the stimulation can also be enhanced using smaller electrodes. Nitsche et al. found that M1 stimulation with a 3.5 cm2 electrode over the abductor digiti minimi location (defined as the best site for obtaining MEPs using a single TMS pulse) is capable of producing focal changes in excitability of the abductor digiti minimi motor representation without changing excitability of the nearby first dorsal interosseous representation. Modeling can help illuminate the distribution of current and should be considered for electrode arrangements.

In summary, tDCS offers a non-invasive means to modulate cortical excitability with reasonable topographic resolution (differentiating for example motor from prefrontal effects). The technique can be applied in children and adults safely and sham tDCS allows for reliable blinding of the intervention. LTP or LTD can be induced depending on the polarity. Use of appropriate electrode montages can promote focality of the effects and modeling can help define the optimal montage for a given indication.

While the invention has been described in connection with exemplary embodiments, the detailed description is not intended to limit the scope of the invention to the particular forms set forth. The invention is intended to cover such alternatives, modifications and equivalents of the described embodiment as may be included within the spirit and scope of the invention.

What is claimed is:

1. A method of treating an individual having amblyopia, the method comprising the steps of:
providing a dichoptic display, having a first sub-display for displaying images to a first eye of the individual and a second sub-display for displaying images to a second eye of the individual;
providing a video game system in communication with the dichoptic display, the video game system having an input controller to allow the individual to interact with the video game system;
using the video game system to run a video game program having a graphical presentation with a plurality of graphical elements;
using the first sub-display to display a first view of the graphical presentation and the second sub-display to display a second view of the graphical presentation; and
altering at least one of the graphical elements of one of the first or second view of the graphical presentation.

2. The method of claim 1, wherein the at least one graphical element is altered using a luminance pattern.

3. The method of claim 2, wherein the luminance pattern is a sinusoidal luminance pattern.

4. The method of claim 3, wherein the sinusoidal luminance pattern is a Gabor patch.

5. The method of claim 1, further comprising the step of using the dichoptic display to display a nonius stimulus for determining a binocular alignment of the individual.

6. The method of claim 1, further comprising the step of using the dichoptic display to display a suppression check for determining a visual fusion of the individual.

7. The method of claim 1, further comprising the steps of:
providing a transcranial direct current stimulation system in contact with the scalp of the individual; and
using the transcranial direct current stimulation system to cause an electrical current to flow through at least a portion of the individual.

8. A computer readable storage medium having encoded thereon computer readable instructions capable of instructing a computer to:
generate a graphical presentation containing a plurality of graphic elements;
generate a first view of the graphical presentation;
generate a second view of the graphical presentation;
alter at least one element of the second view to create an altered view; and
display the graphical presentation on a dichoptic display, wherein the first view is displayed on a first sub-display of the dichoptic display and the altered view is displayed on a second sub-display; and
receive input from an individual by way of an input controller.

9. The storage medium of claim 8, wherein the at least one altered graphical element is altered using a luminance pattern.

10. The storage medium of claim 9, wherein the luminance pattern is a sinusoidal luminance pattern.

11. The storage medium of claim 10, wherein the sinusoidal luminance pattern is a Gabor patch.

12. The storage medium of claim 8, wherein the computer readable instructions are further capable of instructing a computer to perform a nonius stimulus routine for determining a binocular alignment of the individual.

13. The storage medium of claim 8, wherein the computer readable instructions are further capable of instructing a computer to perform a suppression check routine for determining a visual fusion of the individual.

14. A system for treating an individual having amblyopia, comprising:
a dichoptic display capable of displaying different information to each eye of the individual;
a video game system in communication with the dichoptic display and configured to display graphical information to the individual by way of the dichoptic display;
an input controller in communication with the video game system configured to allow the individual to interact with the video game system; and
a transcranial direct current stimulation system for providing electrical stimulation to the individual.

15. The system of claim 14, wherein the dichoptic display is wearable.

16. The system of claim 14, wherein the dichoptic display comprises two displays, each display being visible to an eye of the individual.

17. The system of claim 16, wherein the dichoptic display is configured to be worn as glasses.

17. The system of claim 14, wherein the dichoptic display further comprises a monitor and shutter-glasses, the shutter-glasses being synchronized with the monitor to display different information to each eye of the individual.

18. The system of claim 14, wherein the dichoptic display is a monitor, the monitor configured such that a first portion of the monitor is visible to a first eye of the individual and a second portion of the monitor is visible to a second eye of the individual.

19. The system of claim 14, wherein the system is configured to be portable.

20. The system of claim 19, wherein the system is configured to be wearable during use.

21. The system of claim 14, wherein the transcranial direct current stimulation system further comprises an anode and a cathode, and the cathode is configured to contact the scalp of the individual proximate to the occipital region.

22. The system of claim 14, wherein the transcranial direct current stimulation system further comprises an anode and a cathode, and at least one of the anode or the cathode is disposed in a hat.
